(19) United States
(12) Patent Application Publication
(10) Pub. No.: US 2015/0085498 A1
(43) Pub. Date: Mar. 26, 2015

(54) ILLUMINATING APPARATUS WITH LARGE VIEW ANGLE

(71) Applicant: HUIZHOU LIGHT ENGINE LTD., HUIZHOU CITY (CN)

(72) Inventor: HONG ZHONG, Hong Kong (CN)

(73) Assignee: HUIZHOU LIGHT ENGINE LTD., HUIZHOU CITY (CN)

(21) Appl. No.: 14/036,341

(22) Filed: Sep. 25, 2013

(51) Int. Cl. F21K 99/00

(52) U.S. Cl. CPC F21K 9/50; F21K 9/135
USPC 362/363

(57) ABSTRACT

An LED lamp where the combination of an enlarged globe having a side cross section that is greater than 180°, LEDs with large view angles and the placement of the LEDs at the periphery of the printed circuit board adjacent the globe generates a view angle for the LED lamp greater than 180°. Further, a method of illumination through an LED lamp weaving supplying electrical power to a plurality of LEDs through a lamp base, generating light through the plurality of LEDs, where the LEDs have a view angle of greater than 120 degrees and are mounted in a circle at a peripheral edge of a printed circuit board, dissipating heat generated by the LEDs through a heat sink coupled to the printed circuit board, and transmitting light from the LEDs through a globe, the globe having a substantially spherical wall extending greater than 90 degrees from its vertical centerline.

### TECHNICAL FIELD OF THE INVENTION

The present invention relates to improvements in the viewing angle of light emitting diode (“LED”) lamps. More specifically, an LED light bulb provides a greater than 180° view angle through the combination of a globe or diffuser where the radius of curvature exceeds 180° prior to coupling with the LED light bulb housing, use of LEDs with enlarged view angles and placement of the LEDs along the periphery of the printed circuit board.

This application refers to products and publications, both of which are incorporated herein by reference.

### BACKGROUND OF THE INVENTION

LEDs are highly energy-efficient light sources, which makes them more desirable than other types of light sources, for example, incandescent or fluorescent lighting. In addition, LED light bulbs have advantages of taking up a relatively small volume, having low power consumption, having a long service life and generating high light output. For these reasons, LED light bulbs are now replacing traditional light bulbs in many instance.

LED light bulbs come in many different configurations, which tend to be constrained because of the mounting and control requirements of the LEDs. Typically, LEDs are mounted on a printed circuit (“PC”) board that contains electrical connections for powering and/or controlling the LEDs. LED light bulbs also usually have a heat sink for dissipating heat generated by the LEDs and a housing for containing the components and connecting to the lamp cap or connector. The PC board, heat sink and housing are configured such that the PC board containing the LEDs is typically mounted level with where the globe connects to the housing. In this configuration, the PC board and housing block the view angle of the LEDs. In addition, light emitted by LEDs also tends to be fairly directional, that is, the emitted light tends to be projected primarily along the central vertical axis of the LED, which is typically an asymmetric axis of the LED bulb. Off the vertical axis, light intensity from the LEDs drop off often fairly dramatically. The result of these configurations is that most LED light bulbs can provide only a 180° total view angle. Accordingly, an LED bulb having increased view angle would be beneficial.

Therefore, it is with respect to these considerations and others that the present invention has been made.

### SUMMARY OF THE INVENTION

In light of the above, there exists a need to further improve the art.

In one aspect of the invention, a LED lamp has a lamp base, a housing coupled to the lamp base, a printed circuit board coupled to the housing, where the printed circuit board has a circular peripheral edge, a plurality of LEDs mounted on the printed circuit board proximate the circular peripheral edge of the printed circuit board, with the plurality of LEDs having a view angle of over 120 degrees, a heat sink coupled to printed circuit board for dissipating heat generated by the plurality of LEDs, and a globe coupled to the housing, where the globe has a side cross sectional lighting surface that exceeds 180 degrees.

In another aspect of the invention, the lamp base has a live contact and a neutral contact for supplying electrical power to the LED lamp.

In another aspect of the invention, the globe can be made from plastic or glass.

In another aspect of the invention, the plurality of LEDs are approximately 3 millimeters from the circular peripheral edge of the printed circuit board. The plurality of light emitting diodes can have a typical viewing angle of 140 degrees.

In another aspect of fee Invention, the plurality of LEDs are disposed as dual concentric rings with an outer ring adjacent the circular peripheral edge of the printed circuit board and the inner ring disposed inward from and adjacent to the outer ring.

In yet another aspect of the invention, a method of illumination through an LED lamp having the steps of supplying electrical power to a plurality of LEDs through a lamp base, generating light through the plurality of LEDs, where the LEDs have a view angle of greater than 120 degrees and are mounted in a circle at a peripheral edge of a printed circuit board, dissipating heat generated by the LEDs through a heat sink coupled to the printed circuit board and transmitting light from the LEDs through a globe, the globe having a substantially spherical wall extending greater than 90 degrees from its vertical centerline.

### BRIEF DESCRIPTION OF THE DRAWINGS

The figures are for illustration purposes only and are not necessarily drawn to scale. However, the invention itself may best be understood by reference to the detailed description which follows when taken in conjunction with the accompanying drawings in which:

FIG. 1 is a perspective view of a first exemplary embodiment of the present invention;

FIG. 2 is a top view of the first exemplary embodiment of the present invention;

FIG. 3 shows a side view of the first exemplary embodiment of the present invention;

FIG. 4 shows a graphical side view of the first exemplary embodiment, depicting the increased viewing angle of the LEDs; and

FIG. 5 is a graph of the light intensity distribution as a function of viewing angle for the first exemplary embodiment.

### DETAILED DESCRIPTION OF THE INVENTION

Various embodiments will now be described with reference to the accompanying drawings, which form a part of the description, and which show, by way of illustration, specific embodiments. However, this invention may be embodied in many different forms and should not be construed as limited to the specific embodiments set forth herein. Rather, these embodiments are provided so that this disclosure will be thorough and complete, and will fully convey the scope of the invention to those skilled in the art. As described below, various embodiments of the invention may be readily combined without departing from the scope or spirit of the invention.

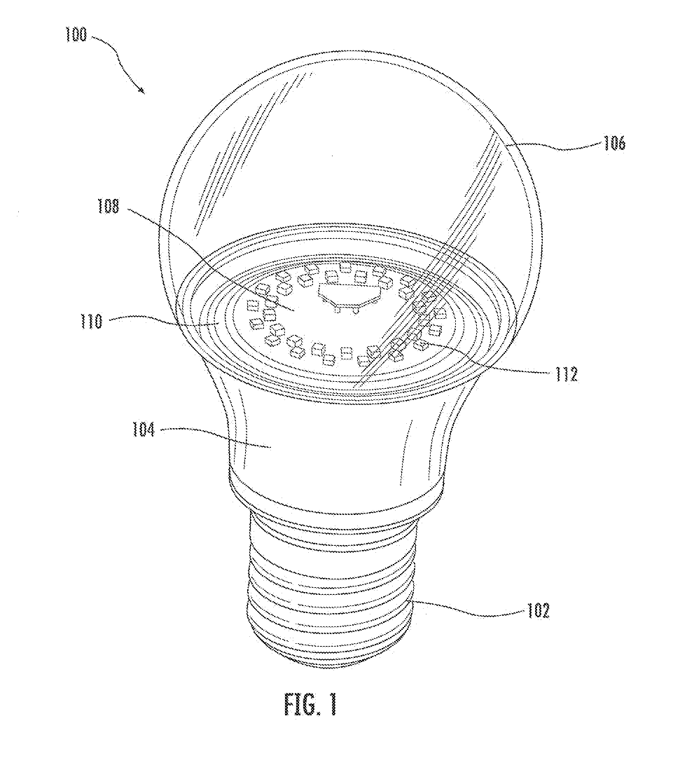

As shown in FIG. 1, LED lamp 100 is comprised of threaded lamp cap 102, housing 104 and globe 106. Threaded lamp cap 102 can be comprised of, for example, an Edison (e.g., E27, or E26) threaded configuration that has a connection button that couples the bottom of lamp cap 102 with contacts from an electrical power source, that is, a light socket. While lamp cap 102 is shown in the figures, the present invention is not limited to the disclosed embodiment and lamp cap 102 can be shaped in the form of a connector having any known configuration, for example, a double bayonet style mounting, a smooth shaped connector, . . . etc., for connection to any number of known wall or ceiling sockets. Housing 104 is attached to lamp cap 102 and encloses the electrical connections required for providing power to the LEDs within LED lamp 100. Globe 106 performs, among other things, a light diffusing function by being made from transparent, frosted or other light transmissive/diffusive material. Globe 106 can be made of glass, plastic or other suitable material. Typically, the lower portion of globe 106 tapers inward to fit with the upper portion of housing 104.

Proximate where housing 104 meets globe 106 is disposed LED PC board 108. In one embodiment. LED PC board 108 is mounted on heat sink 110 which in turn can be thermally connected to either or both of housing 104 or globe 106. Heat sink 110 is preferably made of a suitable heat conductive material, such as for example, copper, aluminum, alloys of copper or aluminum, steel, cast iron, plastics, thermoplastics and/or a combination thereof. The heat generated by the LEDs can be dissipated by heat sink 110 through housing 104 into the surrounding atmosphere. One of the advantages of providing an internal heat sink is that it makes the lamp appears and handles more like a traditional incandescent light bulb.

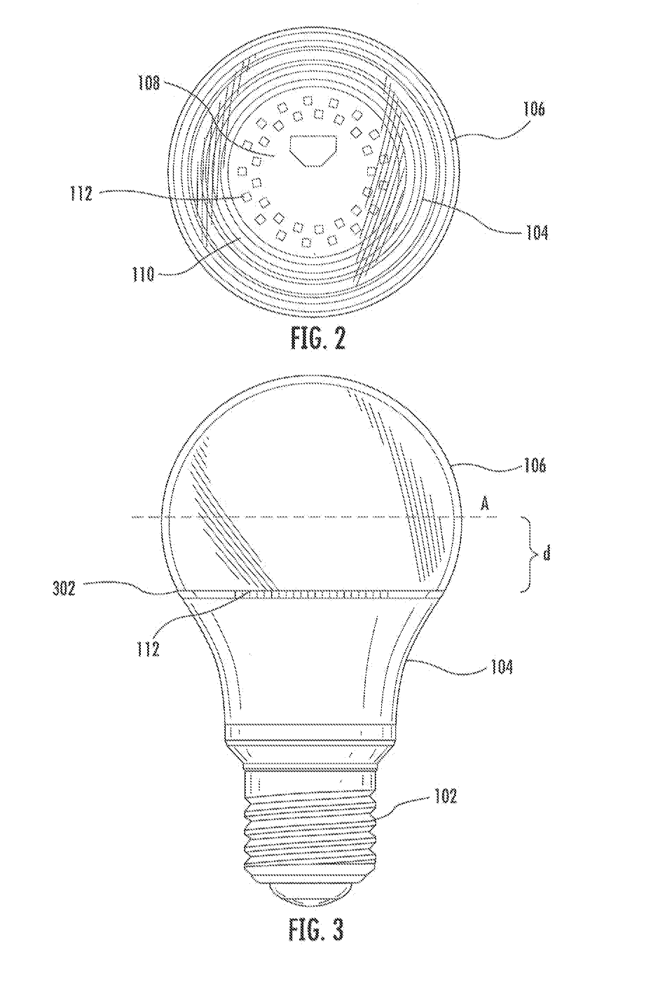

As shown in FIG. 2, LEDs 112 are mounted on LED PC board 108. LEDs 112 typically are comprised of a series of arrays mounted equilaterally around the periphery of LED PC Board 108. In one embodiment, LEDs 112 are mounted, approximately 2 to 3 mm from the edge of LED board 108. In another embodiment, a second series of LED arrays can be mounted just inside the first series of arrays and offset so that the first and second series of LED arrays have the same center point with the second series of arrays being mounted in the spaces between the first series of LEDs. In one preferred embodiment, LEDs 112 have a viewing angle of 140°. An example of such an LED is the Cree XLamp XQ-B LED commercially available from Cree (see http://www.cree.com/led-components-and-modules/products/xlamp/discrete-directional/xlamp-xqb). The relative luminous intensity (as a percentage) is close to 100% within approximately 30° of the vertical centerline. The relative luminous intensity drops thereafter to approximately 15% at an angle of approximately 90° from the vertical centerline.

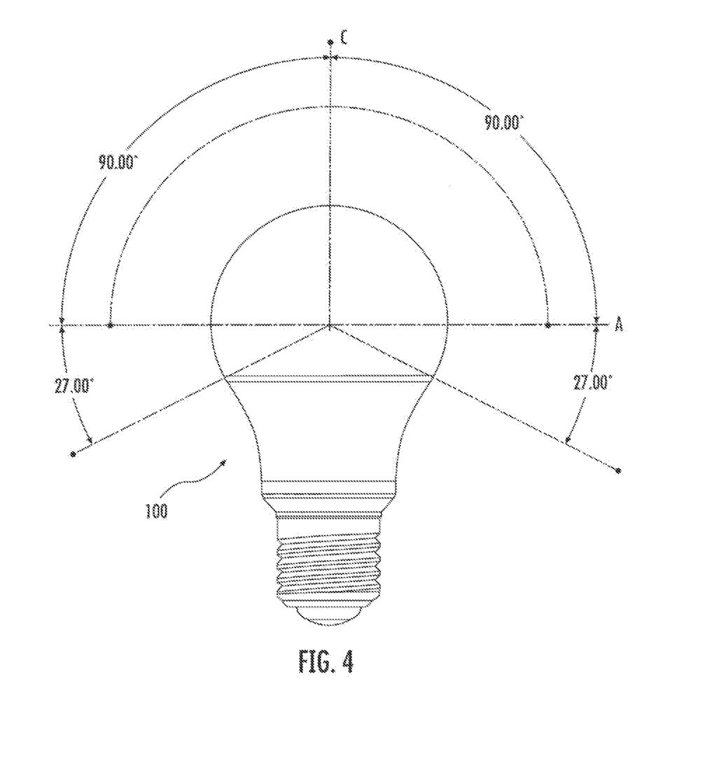

FIG. 3 shows the position of LEDs 112 relative to the connection point between globe 106 and housing 104. Globe center line A shows the approximate centerline diameter for the radius of curvature of globe 106. As apparent globe-housing interlace 302 is located a distance d below globe centerline A. For this portion of globe 106 below globe centerline A, globe 106 curves inwardly. LEDs 112 are located approximately at globe-housing interface 302.

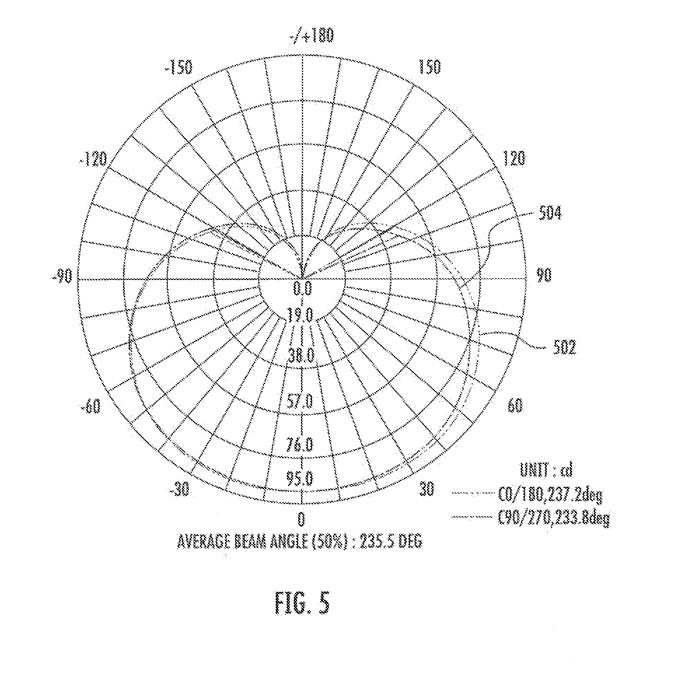

The benefit of combining the inward curvature of globe 106 over distance d, placing LEDs 112 along the peripheral edge of LED PC board 108 and the use of LEDs with a large view angle is that the viewing angle for LED lamp 100 is greater than 180°. A graphical depiction of the increased viewing angle is shown in FIG. 4. Vertical centerline C for LED 100 is disposed on the longitudinal axis of the LED lamp. Globe centerline A is shown 90° from vertical centerline C. The increased viewing angle in this embodiment is shown as 27°.

The relative luminous intensity as a function of viewing angle for two representative embodiments of LED lamp 100 is shown in FIG. 5 as curves 502 and 504. At 0°, which corresponds with vertical centerline C, the relative luminous intensity is approximately 90%. As the angle from vertical centerline C increases, the relative luminous intensity decreases until it reaches approximately 65 percent at 90°. Past 90°, there is significant luminous intensity until it reaches less than approximately 50 percent at 117°.

Although specific embodiments have been described herein, it will be appreciated by those of ordinary skill in the art that a variety of alternate and or equivalent implementations can be substituted for the specific embodiments shown and described without departing from the scope of the present invention. For example, although a bulb-shaped lamp has been illustrated, the present invention can be applied to the construction of other configurations of an LED lighting fixture. The present invention can be used in any LED lamp configuration where an increased viewing angle is created through the use of a combination of an increase in THE size of the globe, an LED with a large view angle and placement of the LEDs close to the peripheral edge of the LED PC board.

Although other modifications and changes may be suggested by those skilled in the art, it is the intention of the inventors to embody within the patent warranted hereon all changes and modifications that reasonably and properly come within the scope of their contribution to the art.

What is claimed is:

1. A light emitting diode (“LED”) lamp comprising:
a lamp base having a live contact and a neutral contact for supplying electrical power to the LED lamp;
a housing coupled to the lamp base;
a printed circuit board coupled to the housing, where the printed circuit board has a circular peripheral edge;
a plurality of LEDs mounted on the printed circuit board proximate the circular peripheral edge of the printed circuit board, the plurality of LEDs having a view angle of over 120 degrees;
a heat sink coupled to printed circuit board for dissipating heat generated fey the plurality of LEDs; and
a globe coupled to the housing, the globe having a side cross sectional lighting surface that exceeds 180 degrees.

2. The lighting apparatus of claim 1, wherein the globe is made from plastic or glass.

3. The lighting apparatus of claim 1, wherein the plurality of LEDs are approximately 3 millimeters from the circular peripheral edge of the printed circuit board.

4. The lighting apparatus of claim 1, wherein the plurality of LEDs have a typical viewing angle of 140 degrees.

5. The fighting apparatus of claim 1, wherein the plurality of LEDs are disposed as dual concentric rings with an outer ring adjacent the circular peripheral edge of the printed circuit board and the Inner ring disposed inward from and adjacent to the outer ring.

6. A method of illumination through an LED lamp comprising:
supplying electrical power to a plurality of LEDs through a lamp base having a live contact and a neutral contact;
generating light through the plurality of LEDs, where the LEDs have a view angle of greater than 120 degrees and are mounted in a circle at a peripheral edge of a printed circuit board;
dissipating heat generated by the LEDs through a heat sink coupled to the printed circuit board; and
transmitting light from the LEDs through a globe, the globe having a substantially spherical wall extending greater than 90 degrees from its vertical centerline.

7. The method of claim 6, wherein the globe is made from plastic or glass.

8. The method of claim 6, wherein the plurality of LEDs are approximately 3 millimeters from the circular peripheral edge of the printed circuit board.

9. The method of claim 6, wherein the plurality of LEDs have a typical viewing angle of 140 degrees.

10. The method of claim 6, wherein the plurality of LEDs are disposed as dual coincentric rings with an outer ring adjacent the circular peripheral edge of the printed circuit board and the inner ring disposed inward from and adjacent to the outer ring.

11. An LED lamp comprising:
a housing having a base with a live contact and a neutral contact for supplying power to the LED lamp;
a globe coupled to the housing at a circular interface, the globe having a continuous substantially spherical wall, the globe having a vertical centerline, where the substantially spherical wall extends greater than 90 degrees from the vertical centerline prior to the circular interface; and
an array of LEDs having a view having a view angle of greater than 120 mounted adjacent the circular interface of the housing and globe.

12. The LED lamp of claim 11, wherein the globe is made from plastic or glass.

13. The LED lamp of claim 11, wherein the plurality of LEDs are mounted on a peripheral edge of a printed circuit board.

14. The LED lamp of claim 11, wherein the plurality of LEDs have a typical viewing angle of 140 degrees.

15. The LED lamp of claim 11, wherein the plurality of LEDs are disposed as dual concentric rings.
